(19) United States
(12) Patent Application Publication
(10) Pub. No.: US 2013/0180642 A1
(43) Pub. Date: Jul. 18, 2013

(54) Self-stiffened composite panel and process for making same

(71) Applicants: Philippe BLOT, Nantes (FR); Laurent GIUSEPPIN, Finhan (FR); Bernard DUPRIEU, Toulouse (FR); Cyrille COLLART, Nantes (FR); Sébastien ALBY, Tournefeuille (FR); Jean-Pierre CABANAC, Tournefeuille (FR)

(72) Inventors: Philippe BLOT, Nantes (FR); Laurent GIUSEPPIN, Finhan (FR); Bernard DUPRIEU, Toulouse (FR); Cyrille COLLART, Nantes (FR); Sébastien ALBY, Tournefeuille (FR); Jean-Pierre CABANAC, Tournefeuille (FR)

(73) Assignee: Airbus Operations (S.A.S.), Toulouse (FR)

(21) Appl. No.: 13/724,475

(22) Filed: Dec. 21, 2012

(30) Foreign Application Priority Data
Dec. 28, 2011 (FR) 11 62499

(51) Int. Cl. B64F 5/00

(52) U.S. Cl. CPC B64F 5/0009
USPC 156/60

(57) ABSTRACT

The invention provides a self-stiffened composite panel including an external skin, an internal skin superposed on the external skin, which covers an internal face of the external skin and at least one stiffener protruding inwards relatively to the internal skin which extends along a longitudinal direction, characterised in that the stiffener is made as one piece with the internal skin and consists of a portion of the internal skin which is located at distance from the external skin. The invention also provides a process for making such a self-stiffened panel.

### TECHNICAL FIELD

The invention relates to a panel including elements increasing the rigidity thereof and a process for making such a panel.

The invention more particularly relates to a panel of composite material of the so-called “self-stiffened” type, intended to be applied to an aircraft fuselage or structure box.

### STATE OF PRIOR ART

A self-stiffened panel generally consists of a planar or curved plate on which stiffeners are added, in order to improve this plate resistance to mechanical loads applied thereto.

According to a known embodiment, the plate is made of composite material, wherein stiffeners, also of composite material, are added. Several methods are used to perform assembly of the stiffeners onto the plate.

A first method, called “secondary bonding” consists in bonding each stiffener onto the plate following the polymerization of the plate and the polymerization of the stiffeners.

This method is relatively simple to be implemented. However, it is particularly restrictive, in particular because the surfaces to be bonded should be particularly clean and the shapes of the plate and stiffeners should be matched to one another.

A second method, called “co-bonding” consists in mounting unpolymerized stiffeners on a polymerized plate, or in mounting polymerized stiffeners on an unpolymerized plate.

Then, the assembly is placed into an autoclave, to polymerize the component(s) which were not polymerized.

Such a method is also restrictive in particular because it involves two polymerization steps, and the connection is carried out through bonding once again.

A third method, called “co-curing” consists in assembling through co-curing unpolymerized stiffeners onto the plate which is not polymerized.

This method enables only a single polymerization step to be used. However, this method implies to use means for positioning the stiffeners, as well as for keeping the stiffening elements in the functional shape thereof.

The object of the invention is to provide a panel including stiffeners which is made so as to ensure a sustainable connection between the plate and the stiffeners.

### DISCLOSURE OF THE INVENTION

The invention provides a self-stiffened composite panel including an external skin, an internal skin superposed on the external skin, which covers an internal face of the external skin and at least one stiffener protruding inwards relatively to the internal skin characterised in that the stiffener is made as one piece with the internal skin, and consists in a portion of the internal skin which is located at a distance from the external skin.

Each stiffener is made as one piece with the internal skin so as to have a high connection area between each stiffener and the plate.

Preferably, the internal skin, the external skin and the stiffener are secured to each other during a same connecting step.

Preferably, the stiffener bounds a tubular conduit, together with the external skin.

Preferably, the tubular conduit has a convex, inwardly vertically bulging shape.

Preferably, the panel includes an insert which is received inside the conduit and which has a shape complementary to the shape of the conduit.

Preferably, the insert is made of composite material and is secured to the internal skin and the external skin during the connecting step.

Preferably, the insert is made of composite material and is secured to the internal skin and the external skin through bonding.

The invention thus provides a process for making a self-stiffened composite panel including an external skin, an internal skin superposed on the external skin, which covers an internal face of the external skin and at least one stiffener protruding inwards relatively to the internal skin made as one piece with the internal skin, the process including a step of placing the internal skin onto a mould element, a step of placing an insert onto said internal skin, a step of placing the external skin so as to cover the internal skin and said insert, and a step of simultaneously connecting at least both skins, characterised in that the mould element includes a cavity having a shape complementary to the shape of the stiffener, against the internal wall of which, a portion of the first skin, corresponding to the stiffener, is applied and then the insert is introduced into said throat during the step of placing the insert.

Preferably, the insert is at least partially non-rigidified while being placed and is rigidified together with both skins during the connecting step.

Preferably, the insert is held in shape during the connecting step via a removable element.

Preferably, the insert is fully rigidified while being placed and it is connected to both skins through bonding.

### BRIEF DESCRIPTION OF THE DRAWINGS

Further characteristics and advantages of the invention will appear upon reading the detailed description that follows for the understanding of which the appended drawings will be referred to, wherein:

FIG. 1 is a partial cross-section of a self-stiffened composite panel including a stiffener made in accordance with the invention;

FIGS. 2A-2C are views representing successive steps of making a composite panel according to a first embodiment of the invention;

FIGS. 3A-3D are views representing successive steps of making a composite panel according to a second embodiment of the invention.

### DETAILED DESCRIPTION OF PARTICULAR EMBODIMENTS

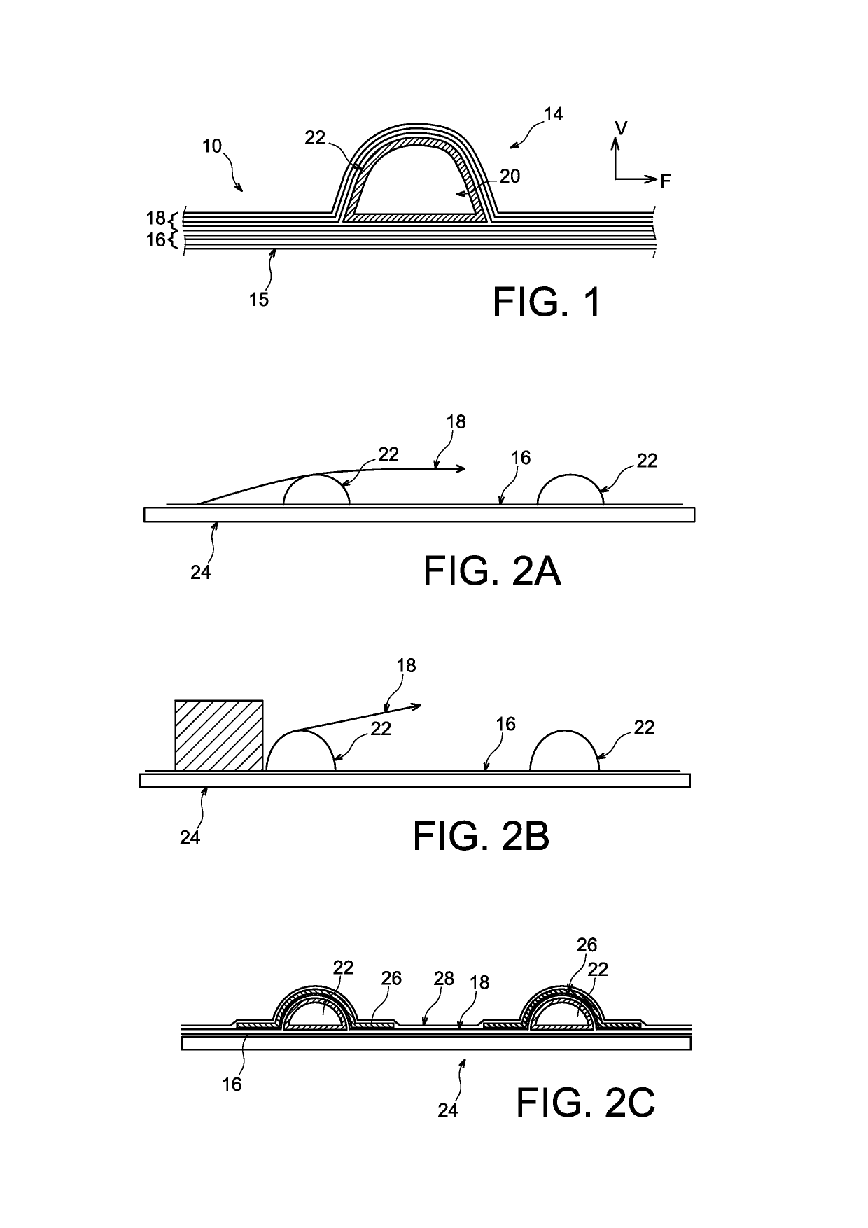

In describing the invention, the vertical and transverse orientations according to the V, T referential frame indicated in FIG. 1 will be assumed in a non-limiting way.

In the description that follows, identical, similar or analogue elements will be designated by the same reference numbers.

It is represented in FIG. 1 a self-stiffened type panel 10, which includes a main plate 12 and a plurality of stiffeners 14, which are attached to the plate 12, of which a single stiffener 14 is represented. In the description that follows, it will be referred to a single stiffener 14, it will be understood that this description is identically applicable to all the other stiffeners 14 of the panel 10.

The plate 12 is made from two skins 16, 18 of polymeric material, that is an external skin 16, which is herein represented at the bottom of FIG. 1, and an internal skin 18 located above the external skin 16.

The skins are made of a same material.

According to a first embodiment, each skin is made of a composite material, comprising fibres of at least one material, called reinforcing fibres, which are connected to each other by a matrix such as a resin. The skins are connected to each other and are rigidified by polymerizing the resin making up the matrix thereof.

According to a second embodiment, each skin is made of a fabric and the skins are connected to each other and rigidified by a resin injected thereafter.

According to a third embodiment, each skin is made of a thermoplastic material capable of being heated up to a temperature higher than the melting temperature of the material, to connect the skins to each other and rigidify them.

It will be understood that the invention is not restricted to these embodiments and that the skins can be made of other materials, without departing from the field of the invention.

The panel 10 is intended, for example, to form part of an aircraft fuselage, the external skin 16 being then located outside the aircraft.

Here, the panel 10 is represented as a substantially horizontal planar plate. It will be understood that the invention is not restricted to this shape of the panel 10, which can consist in a curved and/or bent plate.

Thus, to facilitate the understanding of the invention, the panel 10 is represented along a main horizontal orientation. It will be understood that the panel 10 can have any other orientation without departing from the field of the invention.

The stiffener 14 is intended to be arranged inside the fuselage, it is thus located on the panel 10 internal side. The stiffener 14 is further made such that it protrudes inwards relatively to the internal skin 18.

The stiffener 14 consists in an elongated element which is extended herein along a main longitudinal direction. Since it protrudes vertically inwards relatively to the internal skin, it provides the plate 12 with further flexural stiffness.

The stiffener 14 is made as one piece with the internal skin 18, it consists in a portion of the internal skin 18 which is not adjoining the external skin 16 in order to be extended at a distance from the external skin 16.

Here, the stiffener 14 is shaped such that it has a dome shaped curvature, that is it is convex, inwardly vertically bulging. According to an alternative embodiment, the cross-section of the stiffener may be polygonal, for example rectangular or triangular.

According to an alternative embodiment (not represented), the stiffener 14 is formed by a fold of the internal skin 18, including two portions adjoining each other.

Such an embodiment of the stiffener 14 allows to have a very good attachment mode of the stiffener 14 onto the plate 12 because the attachment area corresponds to the general area of the internal skin 18.

Besides, there is no mounting foot of the stiffener with the plate 12, such that the plate 12 does not include any extra thickness different from the stiffener 14. A higher area is then available for attaching other elements onto the plate 12.

Because of its main convex shape, the stiffener 14 bounds a tubular channel 20 with the external skin 16.

According to a first aspect of the tubular channel 20, its internal volume is left empty, thereby restricting the increase in weight of the plate 12.

According to another aspect of the tubular channel 20, an insert 22 is arranged inside the tubular channel 20 bounded by the stiffener 14. The insert 22 has a cross-section complementary to the cross-section of the tubular channel 20.

According to a preferred embodiment, the insert 22 is also a hollow element, that is a tubular one. According to an alternative (not represented), the insert consists of a solid element.

As will be described in further details in the following, the object of the insert 22 is to hold the portion of the internal skin 18 forming the stiffener 14 in shape during operations for making the panel 10. According to another embodiment, the insert 22 provides some properties to the panel 10, such as mechanical or electrical conductivity properties, for example.

The material and the structure of the insert 22 are thus determined accordingly.

Preferably, the insert 22 is also made of a polymeric material and it is attached to the internal 18 and external 16 skins during the process for making the panel 10, as will be seen in further details in the following.

It is represented in FIGS. 2A-2C different steps of a first embodiment of the process for making the panel 10 just described.

The process includes a first step of placing both skins 16, 18 and the insert 22 onto a mould 24, and then a step of connecting the skins 16, 18.

The mould 24 includes an upper face on which the skins are placed, and which is shaped depending on the shape of the panel 10 to be obtained.

As can be seen in FIG. 2A, the step of placing the skins first consists in positioning, or draping, a first skin onto the mould 24. Herein, this first skin is the external skin 16 of the plate 12.

Then, the insert 22 is laid onto the external skin 16, at the position corresponding to the future position of the stiffener 14. Herein, two inserts 22 are laid onto the external skin 16 such that the panel will include two stiffeners 14.

Then, the internal skin 18 is draped onto the external skin 16 and the inserts 22.

As represented in FIG. 2B, draping the internal skin 18 is carried out by applying on the one hand some tension on the portion of the internal skin 18 which is not yet in contact on the external skin 16 or the inserts 22, and by exerting a gradual action of pressing the internal skin 18 onto the external skin 16 or the inserts 22, to make sure of a good contact of the internal skin 18 with the external skin 16 or the inserts 22, in particular at the connection between the inserts 22 and the external skin 16.

Then, as can be seen in FIG. 2C, shaping sheets 26 are placed onto the internal skin 18, at the inserts 22, to maintain the internal skin 18 pressing against the inserts 22 in order to obtain stiffeners 14 having the desired shape.

The connecting step can consist of several assembling modes of the skins 16, 18.

According to the embodiment according to which the skins are made of a composite material, the connecting step consists of a step of polymerizing the resin making up each skin. This simultaneous polymerization, or co-curing, of the resin making up both skins 16, 18 enables on the one hand both skins 16, 18 to be connected together and, on the other hand, the skins 16, 18 to be rigidified.

According to the embodiment according to which the skins are made of a fabric material, the connecting step consists in injecting a resin onto the skins 16, 18, each consisting of a fabric. The resin is then polymerized so as to connect both skins 16, 18 together and to rigidify the skins 16, 18.

According to the embodiment according to which the skins are made of a thermoplastic material, the connecting step consists in heating each skin at a temperature higher than the melting temperature of the material, so as to connect both skins 16, 18 together and to rigidify the skins 16, 18.

The connecting step consists in placing a vacuum blanket 28 above the assembly comprising the skins 16, 18, the inserts 22 and the shaping sheets 26, creating an air vacuum between the mould 24 and the vacuum blanket 28, and then making the connection of the skins 16, 18 as previously defined.

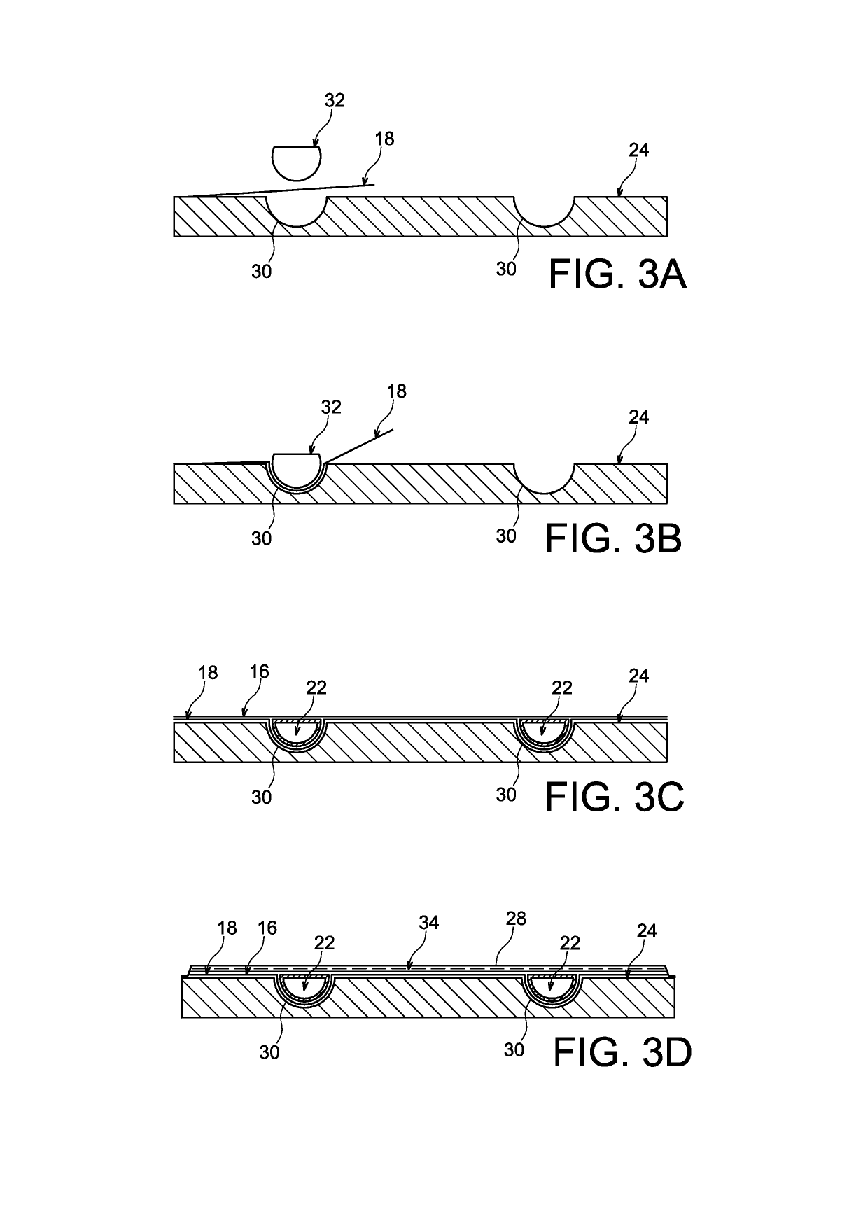

It is represented in FIGS. 3A-3D different steps of a second embodiment of the process for making the panel 10.

The process includes a first step of placing both skins 16, 18 and the insert 22 onto a mould 24, and then a step of connecting the skins 16, 18 as previously defined. Thus, at the end of the connecting step, the skins 16, 18 and the stiffener 14 are connected to each other and are hardened.

The mould 24 includes an upper face on which the skins 16, 18 are placed, and which is shaped depending on the shape of the plate 12 to be obtained. The mould 24 further includes cavities 30 having a cross-section complementary to the cross-section of the stiffeners 14 to be obtained.

As can be seen in FIG. 3A, the step of placing the skins first consists in positioning, or draping, a first skin onto the mould 24. Herein, this first skin is the internal skin 18 of the plate 12.

The internal skin 18 is thus affixed against the upper face of the mould 24 and thus against the internal wall of each cavity 30.

To this end, a tool 32 having a shape complementary to the shape of the cavity is used to repel the internal skin 18. Preferably, the shape of the tool 32 is identical to the shape of each insert 22.

Then, an insert 22 is placed inside each cavity 30, such that the portion of the internal skin 18, which is intended to form a stiffener 14, is kept pressing against the internal wall of the cavity 30 associated by the insert 22.

When each insert 22 is received in the associated cavity 30, its upper surface is flushed with the upper surface of the internal skin 18.

Finally, as represented in FIG. 3C, the external skin 16 is draped onto the internal skin 18 and the inserts 22.

As can be seen in FIG. 3D, the connection step consists in placing a pressure distributing plate 34 above the external skin 16 and then placing a vacuum blanket 28 above the pressure distributing plate 34.

An air vacuum is then created between the mould 24 and the vacuum blanket 28, and then the connection of the skins 16, 18 is carried out as previously defined. Thus, at the end of the connecting step, the skins 16, 18 and the stiffener 14 are connected to each other and are hardened.

As said previously, each insert 22 is made of a polymeric material similar to the material of both skins 16, 18 and it is attached to both skins 16, 18.

According to a first aspect of each insert 22, when the skins 16, 18 and the insert 22 are made of composite material, the insert 22 is not polymerized upon being placed into the associated cavity 30. It then forms a green (or fresh) element, which cannot retain a shape on its own neither when it is placed nor during the connecting step.

Moreover, according to another aspect, the skins 16, 18 and the insert 22 are made of thermoplastic material, or of composite material and the insert 22 is partially polymerized when placed on the first skin. According to this other aspect, the insert 22 is rigid enough to retain its shape when being placed, but it cannot retain its shape during the polymerization step.

Such embodiments of the insert 22, according to which the insert is partially rigid or is not rigid, enable the connection of the skins 16, 18 with the insert 22 to be improved. This connection is particularly resistant and does not require using other attaching means.

However, the insert 22 cannot support pressure strains during the curing step.

To hold the insert in its shape, an internal chuck (not represented) is provided inside the insert 22 to hold the insert 22 in shape, during the connecting step, to support pressures undergone.

The chuck consists of a removable element and is removed from the insert 22 at the end of the connecting step. For example, the chuck consists of an inflatable bladder which is inflated during the placing step, which is maintained in its inflated state during the connecting step and which is deflated subsequently to the curing step, for the extraction thereof to be easier.

According to another embodiment, the insert 22 is fully polymerized when placed onto the first skin. Thus, the insert 22 is rigid enough to resist to pressure strains during the connecting step, which eliminates the need for a chuck such as previously described, unlike both previous embodiments.

However, the connection of the insert can only be made by making use of a further bond.

According to an alternative embodiment of the invention, regarding each of both processes for making the panel 10 previously described, and according to an embodiment of the panel 10 for which the internal volume of the tubular channel 20 is left empty, the inserts 22 are removed from the panel 10 subsequently to the step of connecting the skins 16, 18. To enable each insert 22 to be extracted, according to a first aspect, the shape of the stiffeners 14 and the inserts 22 is suitable for an extraction of the inserts 22, for example the stiffeners 14 and the inserts 22 are cone-shaped.

According to another aspect, the inserts 22 are capable of being destroyed subsequently to the connecting step, they are for example made of water soluble materials.

1. A process for making a self-stiffened composite panel including an external skin, an internal skin superposed on the external skin, which covers an internal face of the external skin and at least one stiffener protruding inwards relatively to the internal skin made as one piece with the internal skin, the process including:
a step of placing the internal skin onto a mould element,
a step of placing an insert onto said internal skin,
a step of placing the external skin so as to cover the internal skin and said insert, and
a step of simultaneously connecting at least both skins, characterised in that the mould element includes a cavity having a shape complementary to the shape of the stiffener, against the internal wall of which, a portion of the first skin, corresponding to the stiffener, is applied and then the insert is introduced into said throat during the step of placing the insert.

2. The process according to claim 1, characterised in that the insert is at least partially non-rigidified while being placed and is rigidified together with both skins during the connecting step.

3. The process according to claim 1, characterised in that the insert is held in shape during the connecting step via a removable element.

4. The process according to claim 1, characterised in that the insert is fully rigidified while being placed and it is connected to both skins through bonding.
